(19) United States
(12) Patent Application Publication
(10) Pub. No.: US 2015/0273395 A1
(43) Pub. Date: Oct. 1, 2015

(54) REDUCTANT QUALITY AND SCR ADAPTION CONTROL SYSTEM

(71) Applicant: GM Global Technology Operations LLC, Detroit, MI (US)

(72) Inventors: John A. Catalogna, Commerce Twp., MI (US); Justin Adam Shetney, Livonia, MI (US)

(73) Assignee: GM Global Technology Operations LLC, Detroit, MI (US)

(21) Appl. No.: 14/226,029

(22) Filed: Mar. 26, 2014

(51) Int. Cl. B01D 53/94; G05B 15/02

(52) U.S. Cl. CPC B01D 53/9495; G05B 15/02

(57) ABSTRACT

An exhaust gas treatment system including a reductant delivery system configured to introduce reductant solution to an exhaust gas flowing through the exhaust gas treatment system. An amount of the reductant solution injected is based on an initial control parameter. A selective catalyst reduction device is configured to chemically react with the reductant solution to induce a NOx conversion that reduces a level of NOx in the exhaust gas. A reductant quality sensor is configured to generate an electrical signal indicating a quality of the reductant solution. The exhaust gas treatment system further includes a reductant quantity control module configured to generate a pre-control parameter that modifies the initial control parameter based on the quality of the reductant solution.

### FIELD OF THE INVENTION

The present disclosure relates to exhaust gas treatment systems, and more specifically, to an exhaust gas treatment system including a reductant quality system and SCR adaption control system.

### BACKGROUND

Exhaust gas emitted from an internal combustion (IC) engine, is a heterogeneous mixture that may contain gaseous emissions such as carbon monoxide (CO), unburned hydrocarbons (HC) and oxides of nitrogen (NOx) as well as condensed phase materials (liquids and solids) that constitute particulate matter. Catalyst compositions typically disposed on catalyst supports or substrates are provided in an engine exhaust system to convert certain, or all of these exhaust constituents into non-regulated exhaust gas components.

Exhaust gas treatment systems typically include one or more selective catalytic reduction (SCR) devices and a reductant delivery system. The SCR devices include a substrate having a washcoat disposed thereon that operates to reduce the amount of NOx in the exhaust gas. The reductant delivery system injects a reductant solution including an active reductant such as, for example, ammonia (NH₃), urea (CO(NH₂)₂), etc., which mixes with the exhaust gas. When the proper amount of reductant is supplied to the SCR device under the proper conditions, the reductant reacts with the NOx in the presence of the SCR washcoat to reduce the NOx emissions. The quality of the reductant solution may affect the efficiency at which the SCR device effectively reduces the NOx emissions. For example, the reductant solution may be diluted with excess water or replaced with water entirely. The reduced quality of the reductant may therefore reduce the effectiveness of the SCR device.

### SUMMARY OF THE INVENTION

According to at least one exemplary embodiment, an exhaust gas treatment system including a reductant delivery system 15 configured to introduce reductant solution to an exhaust gas flowing through the exhaust gas treatment system. An amount of the reductant solution injected is based on an initial control parameter. A selective catalyst reduction device is configured to chemically react with the reductant solution to induce a NOx conversion that reduces a level of NOx in the exhaust gas. A reductant quality sensor is configured to generate an electrical signal indicating a quality of the reductant solution. The exhaust gas treatment system further includes a reductant quantity control module configured to generate a pre-control parameter that modifies the initial control parameter based on the quality of the reductant solution.

According to another exemplary embodiment, an electronic control module is configured to control an amount of reductant solution introduced into an exhaust gas. The control module includes a memory unit and a quantity pre-control unit. The memory unit is configured to store a lookup table that cross-references a Δ_{NOX} conversion value with an estimated percentage of active reductant included in the reductant solution. The quantity pre-control unit is configured to receive an initial control parameter that sets the amount of reductant solution injected into an exhaust gas. The quantity pre-control unit is further configured to determine a diluted amount of an active reductant included in the reductant solution based on a comparison between the Δ_{NOX} conversion value and the look up table, and to generate a pre-control parameter that modifies the initial control parameter based on the amount of dilution of an active reductant.

In yet another exemplary embodiment, a method of controlling an amount of reductant solution introduced into an exhaust gas comprises introducing a reductant solution to an exhaust gas according to an initial control parameter, and inducing a NOx conversion that reduces a level of NOx in the exhaust gas in response to the reductant solution. The method further includes determining a quality of the reductant solution. The method further includes generating a pre-control parameter that modifies the initial control parameter based on the quality of the reductant solution.

The above features of the inventive teachings are readily apparent from the following detailed description of the invention when taken in connection with the accompanying drawings.

### BRIEF DESCRIPTION OF THE DRAWINGS

Other features and details appear, by way of example only, in the following detailed description of embodiments, the detailed description referring to the drawings in which:

FIG. 1 is a schematic diagram of an exhaust gas treatment system including a reductant solution quality system in accordance with exemplary embodiments;

FIG. 2 is an electronic control module configured to generate a pre-control quantity control parameter that adjusts a quantity of a reductant solution delivered by an exhaust treatment system according to an exemplary embodiment;

FIG. 3 is a flow diagram illustrating a method of controlling a quantity of injected reductant solution based on a quality of the reductant solution determined by a reductant quality sensor of an exhaust treatment system according to an exemplary embodiment; and

FIG. 4 is a flow diagram illustrating a method of controlling a quantity of injected reductant solution based on a quality of the reductant solution determined by a reductant quality sensor of an exhaust treatment system according to another exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

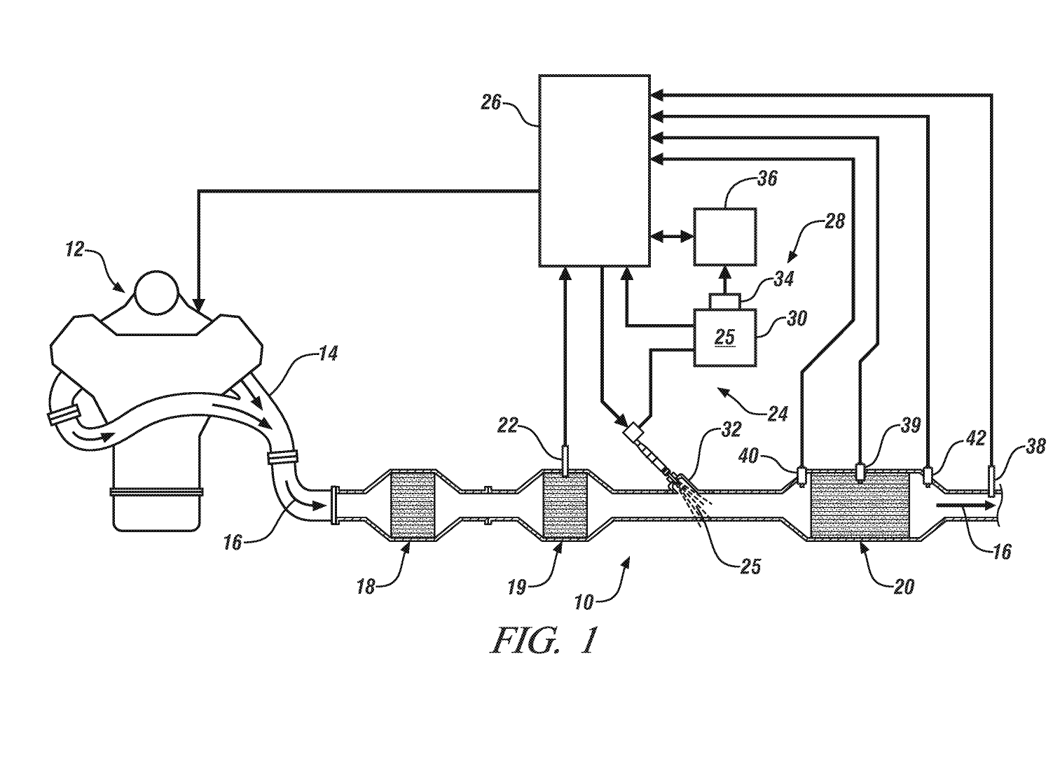

Referring now to FIG. 1, an exemplary embodiment is directed to an exhaust gas treatment system 10, for the reduction of regulated exhaust gas constituents of an internal combustion (IC) engine 12. The exhaust gas treatment system 10 described herein can be implemented in various engine systems. Such engine systems may include, for example, but are not limited to diesel engine systems, gasoline direct injection systems, and homogeneous charge compression ignition engine systems.

The exhaust gas treatment system 10 generally includes one or more exhaust gas conduits 14, and one or more exhaust treatment devices. The exhaust gas conduit 14, which may comprise of several segments, transports exhaust gas 16 from the engine 12 to the various exhaust treatment devices of the exhaust gas treatment system 10. The exhaust treatment devices include, but are not limited to, an oxidation catalyst device (“OC”) 18, a particulate filter (“PF”) 19, and a selective catalytic reduction (“SCR”) device 20. As can be appreciated, the exhaust gas treatment system 10 of the present disclosure may include various combinations of one or more of the exhaust treatment devices 18, 19, and 20 shown in FIG. 1, and/or other exhaust treatment devices (not shown) and is not limited to the present example.

In FIG. 1, as can be appreciated, the OC 18 can be one of various flow-through, oxidation catalyst devices known in the art. In various embodiments the OC 18 may include a flow-through metal or ceramic monolith substrate that is wrapped in an intumescent matte or other suitable support that expands when heated, securing and insulating the substrate. The substrate may be packaged in a stainless steel shell or canister having an inlet and an outlet in fluid communication with the exhaust gas conduit 14. The substrate can include an oxidation catalyst compound disposed thereon. The oxidation catalyst compound may be applied as a washcoat and may contain platinum group metals such as platinum (Pt), palladium (Pd), rhodium (Rh) or other suitable oxidizing catalysts, or combination thereof. The OC 18 may treat unburned gaseous and non-volatile HC and CO, which are oxidized to form carbon dioxide and water, as well as converting NO to NO₂ to improve the ability of the SCR device 20 to convert NOx.

The PF 19 may be disposed downstream from the OC 18 and filters the exhaust gas 16 of carbon and other particulate matter. According to at least one exemplary embodiment, the PF 19 may be constructed using a ceramic wall flow monolith exhaust gas filter substrate that is wrapped in an intumescent or non-intumescent matte (not shown) that expands, when heated to secure and insulate the filter substrate which is packaged in a rigid, heat resistant shell or canister. The shell of the canister has an inlet and an outlet in fluid communication with exhaust gas conduit 14. It is appreciated that the ceramic wall flow monolith exhaust gas filter substrate is merely exemplary in nature and that the PF 19 may include other filter devices such as wound or packed fiber filters, open cell foams, of sintered metal fibers, for example.

Exhaust gas 16 entering the PF 19 is forced to migrate through porous, adjacently extending walls, which capture carbon and other particulate matter from the exhaust gas 16. Accordingly, the exhaust gas 16 is filtered prior to being exhausted from the vehicle tailpipe. As exhaust gas 16 flows through the exhaust gas treatment system 10, the PF 19 realizes a pressure drop across the inlet and the outlet. One or more pressure sensors 22 (e.g., a delta pressure sensor) may be provided to determine the pressure differential (i.e., Δp) across the PF 19. Further, the amount of particulates deposited in the PF 19 increases over time, thereby increasing the exhaust gas backpressure realized by the engine 12. A regeneration operation may be performed that burns off the carbon and particulate matter collected in the filter substrate and regenerates the PF 19 as understood by those of ordinary skill.

The SCR device 20 may be disposed downstream of the PF 19. The SCR device 20 includes a catalyst containing washcoat disposed thereon. The catalyst containing washcoat may chemically react with a reductant solution to convert NOx contained in the exhaust gas into N₂ and H₂O as understood by those of ordinary skill in the art. The catalyst containing washcoat may contain a zeolite and one or more base metal components such as iron (Fe), cobalt (Co), copper (Cu) or vanadium (V) which can operate efficiently to convert NOx constituents in the exhaust gas 16 into acceptable byproducts (e.g., diatomic nitrogen (N₂) and water (H₂O)) in the presence of NH₃. The efficiency at which the SCR device 20 converts the NOx is hereinafter referred to as “NOx conversion efficiency.”

The exhaust gas treatment system 10 illustrated in FIG. 1 further includes a reductant delivery system 24, a control module 26, and a reductant quality system 28. The reductant delivery system 24 introduces a reductant solution 25 to the exhaust gas 16. The reductant delivery system 24 includes a reductant supply source 30 and a reductant injector 32. The reductant supply source 30 stores the reductant solution 25 and is in fluid communication with the reductant injector 32. Accordingly, the reductant injector 32 may inject a selectable amount (m) of reductant solution 25 into the exhaust gas conduit 14 such that the reductant solution 25 is introduced to the exhaust gas 16 at a location upstream of the SCR device 20. The reductant solution 25 may comprise an active reductant including, but not limited to, urea (CO(NH₂)₂), and ammonia (NH₃). The reductant solution 25 may be in the form of a solid, a gas, a liquid, or an aqueous urea solution. For example, the reductant solution 25 may comprise an aqueous solution of NH₃ and water (H₂O).

The solution ratio of the reductant solution 25 may determine the quality of the reductant solution 25 and may affect the efficiency at which SCR device 20 effectively reduces the NOx (i.e., the NOx conversion efficiency). The solution ratio may be based on an amount of active reductant (e.g., urea, NH₃, etc.) in the reductant solution 25. For example, a reductant solution 25 being of a “nominal quality” may provide a first NOx conversion efficiency when operating at effective operating conditions. The “nominal quality” may be determined as a reductant solution having a first solution ratio of 32.5% urea and 67.5% H₂O. A reductant solution 25 having a “reduced quality” may provide a second NOx conversion efficiency that is less than the first NOx conversion efficiency when operating at the effective operating conditions. The “reduced quality” may be determined as a reductant solution 25 having, for example, a second solution ratio of 16.25% urea and 83.75% H₂O. A reductant solution 25 having a “deficient quality” may provide a third NOx conversion efficiency that is less than the first NOx conversion efficiency and the second NOx conversion efficiency when operating at the effective operating conditions. The “deficient quality” may be determined as a reductant solution 25 having, for example, a third solution ratio of 5% urea and 95% H₂O. The effective operating conditions mentioned above may be based on an amount of NH₃ stored on the SCR device 20, an engine operating time, and/or a temperature of the SCR device 20.

The control module 26 may control the engine 12, the regeneration process, the reductant delivery system 24, and the reductant quality system 28 based on data provided by one or more sensors and/or modeled data stored in memory. For example, the control module 26 controls operation of the reductant injector 32 based on 25 according to a reductant storage model. The reductant storage model may determine one or more control parameters (X) that indicate a percentage of the amount of reductant solution 25 to be injected. For example, an initial control parameter (λ₁) set to 1.0 may indicate that one-hundred percent (100%) of the set amount (m) of the reductant solution 25 is to be injected into the exhaust gas 16 during an injection event.

In various embodiments, the control module 26 may determine various parameters (P₁, P₂, P₃, P_{N}) of the exhaust treatment system 10 based on one more temperature sensors. In addition to the Δp, the control module 26 may determine a temperature (T_{GAS}) of the exhaust gas 16, a temperature (T_{PF}) of the PF 19, an amount of soot loaded on the PF 19, a temperature (T_{SCR}) of the SCR device 20, and the amount of NH₃ loaded on the SCR device 20. One or more sensors may output signals indicative of a respective parameter to the control module 26. For example, a first temperature sensor 38 may be disposed in fluid communication with the exhaust gas 16 to generate a signal indicative of T_{GAS} and a second temperature sensor 39 may be coupled to the SCR device 20 to determine T_{SCR}.

The control module 26 further determines the NOx conversion efficiency. The NOx conversion efficiency may be measured to determine a measured NOx conversion efficiency and/or may be predicted using a model stored in memory of the control module 26. The measured NOx conversion efficiency may be based on, for example, a differential between a NOx level determined by first NOx sensor, i.e., an upstream NOx sensor 40, and a NOx level determined by a second NOx sensor, i.e., a downstream NOx sensor 42.

The modeled NOx conversion efficiency may predict or determine an expected NOx conversion efficiency based on one or more input parameters. The input parameters may include one or more of the parameters (P₁, P₂, P₃, P_{N}) described above. The control module 26 may then utilize the NOx conversion model to predict an expected NOx conversion efficiency as a function of the one or more parameter input values.

The reductant quality system 28 includes a reductant quality sensor 34 and an electronic reductant quantity control module 36. The reductant quality sensor 34 is in electrical communication with the reductant solution 25 stored in the reductant supply source 30. Accordingly, the reductant quality sensor 34 determines the solution ratio of the reductant solution 25, and outputs a signal indicating the solution ratio to the reductant quantity control module 36. Based on the solution ratio, the reductant quality sensor 34 may determine the quality of the reductant solution 25 as described in detail above. For example, the reductant quality sensor 34 may determine the reductant solution 25 has a first solution ratio (e.g., 32.5% urea and 67.5% H₂O). Based on the first solution ratio, the reductant quality sensor 34 may determine that the reductant solution 25 has a “nominal quality.” If, however, the reductant quality sensor 34 determines that the reductant solution 25 has a second solution ratio (e.g., 16.25% urea and 83.75% H₂O), then the reductant quality sensor 34 may determine that the reductant solution 25 has a “reduced quality.” The reductant quality sensor 34 may also determine a change of the amount of reductant solution 25 stored in reductant supply source 30. It is appreciated, however, that a separate sensor may be used to detect the amount of reductant solution 25 stored in reductant supply source 30.

The reductant quantity control module 36 may rationalize the operation and output of the reductant quality sensor 34. According to at least one exemplary embodiment, the reductant quantity control module 36 may electrically communicate with the control module 26 to determine a NOx conversion differential value (Δ_{NOX}) based on the measured NOx conversion value and the modeled NOx conversion value. The Δ_{NOX} value may be calculated as the difference between the measured (i.e. actual) NOx conversion efficiency value and the modeled (i.e., predicted) NOx conversion efficiency.

The reductant quantity control module 36 may also store in memory a lookup table (LUT) that cross-references a plurality of quality parameters with an expected Δ_{NOX} value and an expected Δ_{NOX} threshold value. The expected Δ_{NOX} value is a value indicating the expected Δ_{NOX} after injecting a reductant solution 25 having a particular solution ratio. The plurality of quality parameters may include, for example, reductant solution ratio values. The reductant quantity control module 36 may rationalize the reductant quality sensor 34 output based on a comparison between the sensed reductant solution ratio and the Δ_{NOX} value. The rationalization of the reductant quality sensor output may be used to rationalize operation of the reductant quality sensor 34. More specifically, the reductant quantity control module 36 may receive the reductant solution ratio sensed by the reductant quality sensor 34 and may determine a respective expected Δ_{NOX} value. The reductant quality sensor 34 may calculate the Δ_{NOX} value based on measured and modeled NOx values received from the control module 26, and may then compare the actual Δ_{NOX} value to the expected Δ_{NOX} value indicated by the LUT. If the Δ_{NOX} value is below the respective Δ_{NOX} threshold indicated by the LUT, for example, then the reductant quantity control module 36 may determine that the reductant quality sensor 34 output is unsatisfactory. In this regard, the reductant quantity control module 36 may determine that the reductant quality sensor 34 is incorrectly detecting the solution ratio of the reductant solution 25 (i.e., the quality of the reductant solution 25).

According to another embodiment, if the Δ_{NOX} value is equal to or above the respective Δ_{NOX} threshold indicated by the LUT, for example, then the reductant quantity control module 36 may determine that the reductant quality sensor 34 is satisfactory or sufficient. The reductant quantity control module 36 may then dynamically generate a pre-control parameter (λ₂) that adjusts the control parameter (λ₁) to actively adapt performance of the SCR device 20 and improve NOx conversation in response to changes in the quality of the reductant solution 25. In this regard, an increased amount of reductant solution 25 may be injected if the quality of the reductant solution 25 decreases. However, a decreased amount of reductant solution 25 may be injected if the quality of the reductant solution 25 increases.

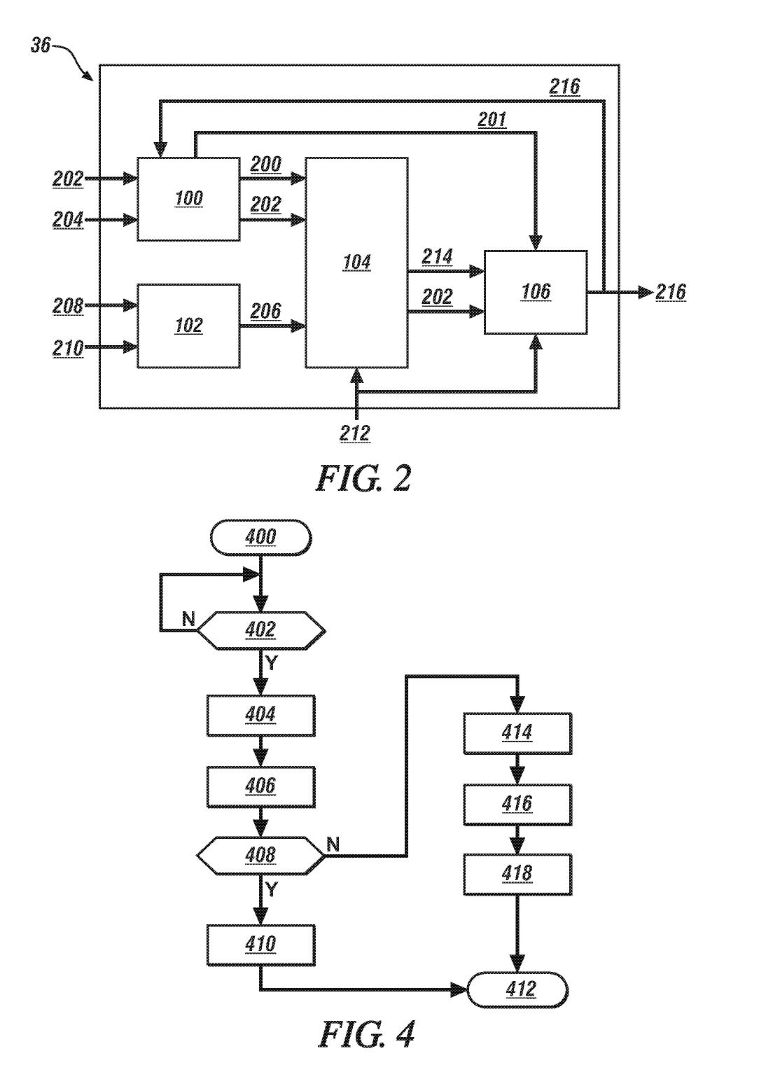

Turning now to FIG. 2, an electronic reductant quantity control module 36 is illustrated according to at least one exemplary embodiment. The reductant quantity control module 36 includes a memory unit 100, an electronic NOx conversion unit 102, an electronic rationalization unit 104, and an electronic quantity pre-control unit 106. The memory unit 100 may store one or more parameter values, threshold values, and/or one or more lookup tables (LUTs). For example, the memory unit 100 may store a first LUT (i.e., sensor quality LUT) 200 that cross-references a plurality of reductant solution ratio values with a respective expected Δ_{NOX} threshold value, and second LUT (i.e., a reductant quality LUT) 201 that cross-references a Δ_{NOX} value (discussed in greater detail below) with an estimated percentage of active reductant (e.g., urea, NH3, etc.) included in the reductant solution 25.

The memory unit 100 may also store an initial quality (Q) value 202 and an initial control parameter (λ₁) 204. The initial quality (Q) value 202 indicates the initial quality of the reductant solution 25 at the time the engine 12 was previously shut off. The initial control parameter (λ₁) 204 indicates an amount of reductant to be introduce to the exhaust gas 16 at the time the engine 12 was previously shut off. The initial control parameter (λ₁) 204 may be initially set to 1.0, for example, indicating the control module 26 was previously set to inject 100% of the reductant solution 25 during an upcoming injection event. The initial quality (Q) value 202 and the initial control parameter (λ₁) 204 value may be stored in memory in response to a key-off event, e.g., when the engine 12 is shut off According to another embodiment, the initial quality (Q) value 202 and the initial control parameter (λ₁) 204 value may each be communicated from the control module 26 and/or the reductant quality sensor 34 in response to a key-on event and/or immediately in response to starting the engine.

The electronic NOx conversion unit 102 may calculate a Δ_{NOX} value 206 based on a measured NOx conversion parameter 208 and a modeled NOx conversion parameter 210. The measured NOx conversion parameter 208 indicates a NOx conversion performed by the SCR device 20 and a modeled NOx conversion parameter 210 indicates an expected NOx conversion performed by the SCR device 20. Each of the measured NOx conversion parameter 208 and the modeled NOx conversion parameter 210 may be received from the control module 26. Accordingly, the Δ_{NOX} value may indicate an error value between the expected NOx conversion and the measured NOx conversion.

The electronic rationalization unit 104 may receive a sensed quality signal 212 indicating the measured quality of the reductant solution 25 from the reductant quality sensor 34. The measured quality may be based on, for example, a sensed solution ratio of the reductant solution 25. The electronic rationalization unit 104 may compare the sensed quality signal 212 against the stored solution ratios of the LUT 200 to determine a corresponding Δ_{NOX} threshold value. The electronic rationalization unit 104 may then compare the Δ_{NOX} value 206 to the determined Δ_{NOX} threshold value to rationalize the reductant quality sensor 34 output. If, for example, the Δ_{NOX} value 206 is below the Δ_{NOX} threshold value, then the electronic rationalization unit 104 may determine that the reductant quality sensor 34 out is unsatisfactory. If, however, the Δ_{NOX} value 206 equals or exceeds the Δ_{NOX} threshold value then the electronic rationalization unit 104 may determine that the reductant quality sensor 34 is sufficient. Accordingly, the electronic rationalization unit 104 may output a rationalization signal 214 indicating the determined rationalization of the reductant quality sensor 34.

The electronic quantity pre-control unit 106 is configured to generate a quantity control signal 216 that dynamically adjusts the amount reductant solution 25 introduced to the exhaust gas 16. According to a first scenario, for example, the quantity control signal 216 is based on the initial control parameter (λ₁) 204. According to a second scenario, for example, the quantity control signal 216 is based on a pre-control parameter (λ₂) that adjusts the initial control parameter (λ₁) 204 according to the rationalization of the reductant quality sensor 34 output indicated by the rationalization signal 214.

The quantity pre-control unit 106 may operate according to the first scenario in response to receiving the rationalization signal 214 indicating that the reductant quality sensor 34 is sufficient. In this regard, if the quality of the reductant solution 25 measured by the quality sensor 34 is of nominal quality (i.e., satisfies a quality threshold value), the quantity pre-control unit 106 outputs a quantity control signal 216 according to the initial control parameter (λ₁).

The quantity pre-control unit 106 may operate according to the second scenario in response to receiving the rationalization signal 214 indicating that the reductant quality sensor 34 output is unsatisfactory. In this regard, the quantity pre-control unit 106 determines that an error may exist in the measured quality of the reductant solution. Accordingly, the quantity pre-control unit 106 outputs a quantity control signal 216 according to the pre-control parameter (λ₂). The pre-control parameter (λ₂) adjusts the initial control parameter (λ₁), thereby adjusting the amount of reductant solution 25 introduced the exhaust gas 16 to compensate for the error in the measured quality of the reductant solution.

It is appreciated that at least one embodiment allows for the quantity pre-control unit 106 to generate one or more adaption parameters (A) based directly on the quality of the reduction solution 25, without requiring input of the rationalization signal 214. In this regard, the quantity pre-control unit 106 may generate the pre-control parameter (λ₂) when the reductant quality sensor 34 indicates that the quality of the reductant solution 25 does not satisfy a quality threshold value. For example, the reductant quality sensor 34 may indicate that the reductant solution 25 is diluted, thereby resulting in a reduced quantity of active reductant (e.g., urea, NH₃, etc.). In response to determining that the quality of the reductant solution 25 is unsatisfactory, the pre-control unit 106 may generate the pre-control parameter (λ₂) as discussed in greater detail below.

When the quantity pre-control module 26 determines a need to generate the pre-control parameter (λ₂), the quantity pre-control unit 106 retrieves the second LUT 201 from the memory unit 100 and the measured quality of the reductant solution 25, i.e., the solution ratio, provided by the reductant quality sensor 34. According to one embodiment, the quantity pre-control unit 106 may utilize the second LUT 201 to determine an estimated percentage of active reductant (e.g., urea, NH₃, etc.) included in the reductant solution 25 based on the measured quality of the reductant solution 25. For example, a reductant quality sensor 34 may determine that the quality of the reductant solution 25 is 5% below a nominal quality which, according to the second LUT 201, indicates that the active reductant (e.g., urea, NH₃, etc.,) of the reductant solution 25 is diluted by 15%.

The quantity pre-control unit 106 may then generate one or more adaption parameters (A) based on the percentage at which the active reductant (e.g., urea, NH₃, etc.) is diluted. According to at least one embodiment, the adaption parameters may be a percentage of the active reductant dilution percentage (e.g., 15%). For example, a first adaption parameter (A₁) may be calculated as 75% of the active reductant dilution percentage (e.g., 15%). Thus, the first adaption parameter (A₁) may be calculated as (0.75×0.15), i.e., A₁=0.1125. Accordingly, a second adaption parameter (A₂) indicating the remaining 25% active reductant dilution percentage may be calculated as (0.25×0.15), i.e., A₂=0.0375.

To compensate for the diluted active reductant in the reductant solution 25, the quantity pre-control unit 106 may generate the pre-control parameter (λ₂) based on the initial control parameter (λ₁) and the first adaption parameter (A₁). According to at least one exemplary embodiment, the pre-control parameter (λ₂) is the sum of the initial control parameter (λ₁) and the first adaption parameter (A₁). Using the values describe above, for example, the pre-control parameter (λ₂)=(1+0.1125), i.e., A₁=1.1125. In this regard, the pre-control parameter (λ₂) adjusts the operation of the control module 26 to inject 111.25% of the reductant solution 25 during the next injection event, as opposed to 100% of the reductant solution previously set by initial control parameter (i.e., λ₁=1.0). Thus, the increased amount of injected reductant solution 25 set by the pre-control parameter (i.e., λ₂=1.1125) may compensate for the diluted active reductant (e.g., urea, NH₃, etc.).

After injecting the reductant solution 25 according to the pre-control parameter (λ₂), the quantity pre-control unit 106 may compare an updated Δ_{NOX} value to a threshold value. If the Δ_{NOX} value satisfies the threshold value, the quantity pre-control unit 106 may store the pre-control parameter (λ₂) in memory and the reductant solution 25 may be injected according to the stored pre-control parameter (λ₂) during subsequent injection events. If, however, the Δ_{NOX} value does not to satisfy the threshold value, the quantity pre-control unit 106 may update the pre-control parameter (λ₂) based on the second adaption parameter (A₂). For example, the quantity pre-control unit 106 may add the second adaption factor (i.e., A₂=0.0375) to the pre-control parameter (i.e., λ₂, =1.1125) to generate the updated pre-control parameter (i.e., λ₃=1.15). Thus, the initial control parameter (λ₁=1.0) is ultimately increased by 15% to compensate for the 15% active reductant dilution of the reductant solution 25. The quantity pre-control unit 106 may continue to update the pre-control parameters as needed to compensate for the unsatisfactory quality (i.e., the diluted active reductant) of the reductant solution 25. According to at least one embodiment, the quantity pre-control unit 106 may generate a reductant solution alert signal when the number of unsatisfactory Δ_{NOX} values occurring after updating the pre-control parameter exceeds a threshold value. The alert signal may include, but is not limited to, a sound, light, or display icon).

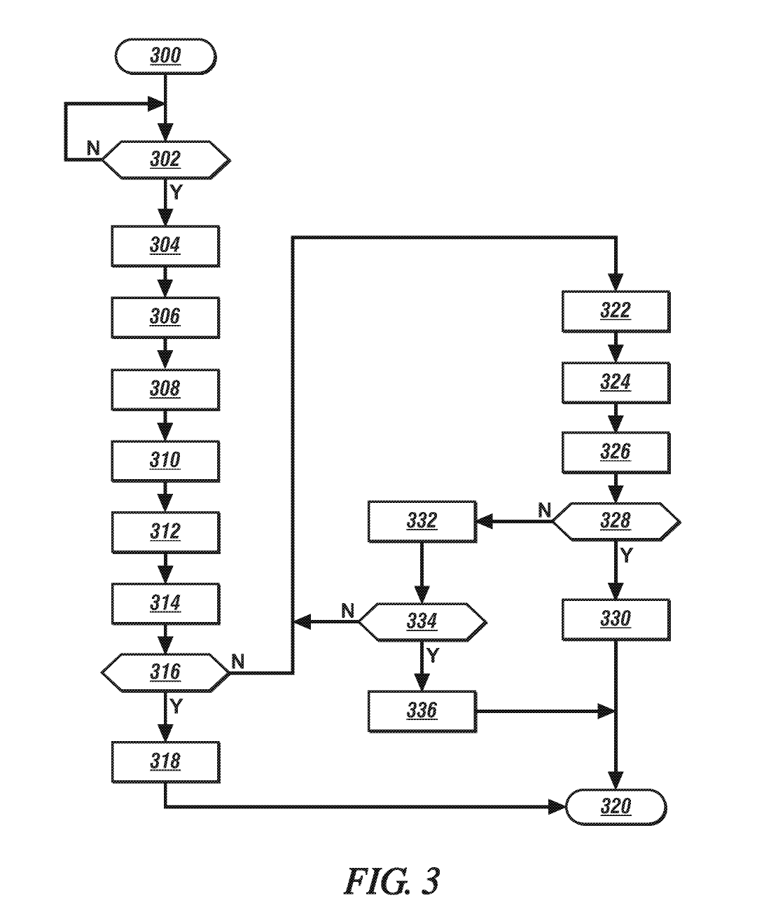

Referring to FIG. 3, a method of controlling an amount of injected reductant solution based on a quality of the reductant solution determined by a quality sensor of an exhaust treatment system is illustrated according to an exemplary embodiment. The method begins at operation 300, and at operation 302, a determination as to whether one or more entry conditions are satisfied is performed. If the entry conditions are not satisfied, the method continues monitoring the entry conditions. If one or more entry conditions are satisfied, the method proceeds to operation 304. The one or more entry conditions may include a change in the level of reductant solution stored in the reductant supply source, an engine-off event, mileage since the reductant supply source has been refilled, and an initial quality of the reductant solution stored in the reductant supply source.

At operation 304, a value of an initial control parameter (λ₁) is determined. At operation 306, a quality of the reductant solution is determined. The quality may be based on, for example, a solution ratio of a reductant solution. The reductant solution may have a first solution ratio including 32.5% of an active reductant and 67.5% H₂O, for example, indicating the reductant solution has a “nominal quality.” The reductant solution may have another solution ratio of 27.5% active reductant and 72.5% H₂O, for example, indicating that the reductant solution has a “reduced quality” with a diluted active reductant.

At operation 308 a measured NOx conversion value is determined and at operation 310 a modeled NOx conversion value is determined. The measured NOx conversion value may be determined by one or more NOx sensors. The modeled NOx conversion value may be determined according to a NOx conversion model as a function of one or parameters (P₁, P₂, P₃, P_{N}). The parameters (P₁, P₂, P₃, P_{N}) may be measured by one or more sensors and/or calculated by an electronic control module. At operation 312, a NOx conversion differential (Δ_{NOX}) based on the measured NOx conversion value and the modeled NOx conversion value is determined.

At operation 314, the reductant quality sensor output is rationalized based on the NOx conversion differential (Δ_{NOX}) and a threshold value. The rationalization of the reductant quality sensor output may be used to rationalize operation of the reductant quality sensor. For example, a Δ_{NOX} threshold value of −0.06 (e.g., −6%) of an expected Δ_{NOX} conversion value may be determined if the solution ratio measured by the reductant quality sensor is 32.5% of an active reductant and 67.5% H₂O. However, a Δ_{NOX} threshold value of −0.15 (e.g., −15%) of an expected Δ_{NOX} conversion value may be determined if the solution ratio measured by the reductant quality sensor is 27.5% of an active reductant and 83.75% H₂O. The Δ_{NOX} threshold value and the corresponding expected Δ_{NOX} conversion value may be organized in a first LUT stored in a memory unit as described in detail above. At operation 316, the reductant quality sensor output is rationalized based on a comparison between the Δ_{NOX} and the determined Δ_{NOX} threshold value. Depending on the reductant quality determined by the reductant quality sensor, the comparison to the Δ_{NOX} threshold value could be different. For example, in the case of a reductant solution having a nominal quality (e.g., of 32.5% urea and 67.5% H₂O), a deficient reductant quality sensor may be determined when Δ_{NOX} is less than the Δ_{NOX} threshold value. In another case of reductant solution having an unsatisfactory quality (e.g., of 5% urea and 95% H₂O), an unsatisfactory reductant quality sensor may be determined when Δ_{NOX} exceeds the Δ_{NOX} threshold value. If the Δ_{NOX} satisfies the Δ_{NOX} threshold value, the reductant quality sensor is determined as sufficient. At operation 318, reductant solution is injected according to the initial control parameter (λ₁), and the method ends at operation 320.

If, however, the Δ_{NOX} does not satisfy the Δ_{NOX} threshold value, the reductant quality sensor is determined as unsatisfactory at operation 316, and an adaption parameter (A) is determined at operation 322. At operation 324, a pre-control parameter (λ₂) is generated based on the initial control parameter (λ₁) and the adaption parameter (A). The reductant solution is injected according to the pre-control parameter (λ₂) at operation 326.

At operation 328, the Δ_{NOX} is again compared to the Δ_{NOX} threshold value to determine if the pre-control parameter (λ₂) has sufficiently compensated for deficient quality of the reductant solution. If the Δ_{NOX} satisfies the Δ_{NOX} threshold value, the pre-control parameter (λ₂) is stored in memory at operation 330, and the method ends at operation 320.

If, however, the Δ_{NOX} does not satisfy the Δ_{NOX} threshold value at operation 328, a flag is set at operation 332. A number of total flags is compared to a threshold range at operation 334. If the number of total flags is below a threshold value at operation 334, the method returns to operation 322 and the method continues generating an updated pre-control parameter to compensate for the unsatisfactory quality of reductant solution, i.e., the diluted active reductant. However, if the number of flags is equal to or exceeds the threshold value, an alert indicating a poor reductant quality is generated at operation 336 and the method ends at operation 320.

Turning to FIG. 4, a method of controlling an amount of injected reductant solution based on a quality of the reductant solution determined by a quality sensor of an exhaust treatment system is illustrated according to another exemplary embodiment. The method begins at operation 400, and at operation 402, a determination as to whether one or more entry conditions are satisfied is performed. If the entry conditions are not satisfied, the method continues monitoring the entry conditions. If one or more entry conditions are satisfied, the method proceeds to operation 404. The one or more entry conditions may include a change in the level of reductant solution stored in the reductant supply source, an engine-off event, mileage since the reductant supply source has been refilled, and an initial quality of the reductant solution stored in the reductant supply source. At operation 404, a value of an initial control parameter (λ₁) is determined. At operation 406, a quality of the reductant solution is determined. The quality of the reductant solution may be determined, for example, according to a measurement executed by a reductant quality sensor. The quality of the reductant solution may be based on a solution ratio that indicates a percentage of active reductant (e.g., urea, NH₃, etc.) contained in the reductant solution.

At operation 408, the quality of the reductant solution is compared to a quality threshold. According to one exemplary embodiment, the percentage of the measured active reductant in the reductant solution is compared to a threshold value. If the quality of the reductant solution satisfies the quality threshold at operation 408, the amount of reductant solution to be introduced to the exhaust gas is set according to the initial control parameter (λ₁) at operation 410, and the method ends at operation 412. If, however, the quality of the reductant solution does not satisfy the quality threshold at operation 408, an adaption parameter is generated at operation 414. According to at least one embodiment, the adaption parameter is based on a percentage at which the active reductant is diluted. The initial control parameter (λ₁) is modified according to the adaption parameter such that a pre-control parameter (λ₂) is generated at operation 416. At operation 418, the amount of reductant solution to be introduced to the exhaust gas is set according to the pre-control parameter (λ₂), and the method ends at operation 412.

As described in detail above, various exemplary embodiments provide a an exhaust gas treatment system including an SCR adaption system that dynamically adjusts a quantity of reductant solution introduced to an exhaust gas based on the quality of the reductant solution. According to at least one feature, the exhaust gas treatment system includes a reductant quality sensor rationalization system that rationalizes the quality of the sensor, and dynamically controls the amount of reductant solution introduced to the exhaust gas to compensate for measurement errors included in the reductant quality measurement. In addition, the amount of reductant solution may be controlled in response to a quality of the reductant solution determined at a key-on event. In this regard, measures to compensate for an unsatisfactory quality of the reductant solution may be executed more quickly, thereby quickly reducing a level of NOx emissions introduced to the atmosphere.

As used herein, the term “module” refers to a hardware module including an Application Specific Integrated Circuit (ASIC), an electronic circuit, a processor (shared, dedicated, or group) and memory that execute one or more software or firmware programs, a combinational logic circuit, and/or other suitable components that provide the described functionality.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An exhaust gas treatment system of a vehicle including an internal combustion engine, comprising:
a reductant delivery system configured to introduce a reductant solution to an exhaust gas flowing through the exhaust gas treatment system, an amount of the reductant solution injected based on an initial control parameter;
a selective catalyst reduction device configured to chemically react with the reductant solution to induce a NOx conversion that reduces a level of NOx in the exhaust gas;
a reductant quality sensor configured to generate an electrical signal indicating a quality of the reductant solution; and
a reductant quantity control module configured to generate a pre-control parameter that modifies the initial control parameter based on the quality of the reductant solution.

2. The exhaust gas treatment system of claim 1, wherein the reductant quantity control module determines a percentage of diluted active reductant included in the reductant solution, and generates an adaption parameter based on the percentage of diluted active reductant.

3. The exhaust gas treatment system of claim 2, wherein the pre-control parameter is a sum of the initial control parameter and the adaption parameter.

4. The exhaust gas treatment system of claim 3, wherein the exhaust gas treatment system further comprises a rationality diagnostic control module configured to rationalize the reductant quality sensor based on a comparison between the quality of the reductant solution and the NOx conversion.

5. The exhaust gas treatment system of claim 4, wherein the rationality diagnostic control module determines a NOx conversion efficiency of the selective catalyst device based on the NOx conversion, and determines a NOx conversion differential based on the NOx conversion efficiency.

6. The exhaust gas treatment system of claim 5, wherein the NOx conversion differential is based on a measured NOx conversion and a modeled NOx conversion.

7. The exhaust gas treatment system of claim 6, wherein the measured NOx conversion is based on a first NOx value determined by a first sensor disposed upstream from the selective catalyst device and a second NOx value determined by a second sensor disposed downstream from the selective catalyst device.

8. The exhaust gas treatment system of claim 7, wherein the modeled NOx conversion is based on a stored NOx conversion model, a level of ammonia (NH₃) stored on the selective catalyst device, and a temperature of the selective catalyst device.

9. The exhaust gas treatment system of claim 8, wherein the rationality diagnostic control module determines a NOx differential threshold based on the quality of the reductant solution, and the comparison further includes comparing the NOx differential to the NOx differential threshold.

10. The exhaust gas treatment system of claim 9, wherein the rationality diagnostic control module determines that the reductant quality sensor is unsatisfactory in response to the NOx differential being below to the NOx differential threshold.

11. The exhaust gas treatment system of claim 10, wherein the quality of the reductant solution is based on a solution ratio comprising an amount of ammonia (NH₃) in the reductant solution.

12. The exhaust gas treatment system of claim 11, wherein the solution ratio is based on an amount of ammonia (NH₃) with respect to an amount of water (H₂O) in the reductant solution.

13. An electronic control module configured to control an amount of reductant solution introduced into an exhaust gas generated by an internal combustion engine, comprising:
a memory unit configured to store a lookup table that cross-references a Δ_{NOX} conversion value with an estimated percentage of active reductant included in the reductant solution; and
a quantity pre-control unit configured to receive an initial control parameter that sets the amount of reductant solution injected into an exhaust gas, to determine a diluted amount of an active reductant included in the reductant solution based on a comparison between the Δ_{NOX} conversion value and the look up table, and to generate a pre-control parameter that modifies the initial control parameter based on the diluted amount of an active reductant.

14. The electronic control module of claim 13, wherein the quantity pre-control unit determines a percentage of diluted active reductant included in the reductant solution, and generates an adaption parameter based on the percentage of diluted active reductant.

15. The electronic control module of claim 14, wherein the pre-control parameter is a sum of the initial control parameter and the adaption parameter

16. The electronic control module of claim 15, further comprising:
a sensor quality lookup table stored in the memory unit, the sensor quality lookup table that indexes a plurality of quality parameters corresponding to a quality of a reductant solution and a NOx conversion threshold value corresponding to each quality parameter;
an electronic NOx conversion unit configured to determine a NOx conversion differential value based on a measured NOx conversion parameter and a modeled NOx conversion parameter; and
an electronic rationalization unit configured to compare the quality of the reductant solution to the quality parameters of the lookup table to determine a corresponding NOx conversion threshold value, and to rationalize the reductant quality sensor based on a comparison of the NOx conversion differential value and the determined NOx conversion threshold value.

17. The control module of claim 16, wherein the measured NOx conversion parameter indicates a NOx conversion efficiency performed by a selective catalyst converter device and the modeled NOx conversion parameter indicates an expected NOx conversion efficiency performed by the selective catalyst converter device.

18. The control module of claim 17, wherein the quality parameters and the quality of a reductant solution are based on an amount of ammonia (NH₃) in the reductant solution.

19. A method of controlling an amount of reductant solution introduced into an exhaust gas generated by an internal combustion engine, the method comprising:
introducing a reductant solution to an exhaust gas according to an initial control parameter;
inducing a NOx conversion that reduces a level of NOx in the exhaust gas in response to the reductant solution;
determining a quality of the reductant solution; and
generating a pre-control parameter that modifies the initial control parameter based on the quality of the reductant solution.

20. The method of claim 19, further comprising:
determining a percentage of diluted active reductant included in the reductant solution; and
generating an adaption parameter based on the percentage of diluted active reductant, wherein the pre-control parameter is a sum of the initial control parameter and the adaption parameter.
